(19) United States
(12) Patent Application Publication
(10) Pub. No.: US 2014/0127387 A1
(43) Pub. Date: May 8, 2014

(54) DISPERSION OF TRIGLYCERIDES

(71) Applicant: DUPONT NUTRITION BIOSCIENCES APS, Copenhagen K (DK)

(72) Inventors: Paul Wassell, East Sussex (GB); Mark Farmer, Oron la Ville (CH); Stuart Andrew Warner, Copenhagen K (DK); Niall W.G. Young, Tjele (DK); Allan Torben Bech, Brabrand (DK); Graham Bonwick, Chester Cheshire (GB); Christopher Smith, Manchester (GB); Brad Alexander Forrest, New South Wales (AU)

(21) Appl. No.: 14/124,877

(22) PCT Filed: Jun. 8, 2012
(86) PCT No.: PCT/GB2012/051292

§ 371 Date: Dec. 9, 2013

Related U.S. Application Data
(60) Provisional application No. 61/497,732, filed on Jun. 16, 2011.

(30) Foreign Application Priority Data
Jun. 9, 2011 (GB) 1109653.4

(51) Int. Cl. A23D 9/00

(52) U.S. Cl. CPC A23D 9/00
USPC 426/607

(57) ABSTRACT

The present invention provides a dispersion comprising (i) a triglyceride continuous phase; (ii) a triglyceride dispersed phase; and (iii) a mono or di ester of glycerol and Moringa oil.

### CROSS REFERENCE TO RELATED APPLICATIONS

This application claims priority to U.S. Provisional Application No. 61/497,732, filed Jun. 16, 2011. This application is also related to: International Patent Application No. PCT/GB2012/051292, filed Jun. 8, 2012 and Foreign Application No. GB1109653.4, filed Jun. 9, 2011. The entire disclosures of the foregoing applications are hereby incorporated by reference in their entirety for all purposes.

### FIELD OF INVENTION

The present invention relates to a dispersion of two triglycerides. In particular, the present invention relates to dispersion which may be consumed as a food or feed or which may be an ingredient in a food or feed.

### BACKGROUND

Dispersions consist of a stable mixture of two materials which are different to each other and in which small droplets or particles of one phase or material are dispersed uniformly throughout the other phase/material. A typical dispersion is a triglyceride dispersion in which a solid fat phase provides one of the continuous or dispersed phases and a liquid oil phase provides the other of the continuous or dispersed phases. Dispersions may be edible dispersions such as a liquid bread improver, a nut butter or shortening.

Dispersions are typically stabilised by the addition of a surfactant and many effective surfactants are known. Many frequently used surfactants are mono or di esters of fatty acids and glycerol. However, providing a source of suitable fatty acids can be problematic. Fatty acids are typically provided from triglycerides and these are sourced from triglycerides oils of natural sources. Many well known sources of oils are plants, animals and fish. However, there is an increasing demand for certain of these oils, and many oils are becoming unacceptable to consumers for ethical or health reasons. There is therefore a desire to provide monoglycerides prepared from source oils which are easily grown, not in high demand, are ethically acceptable and which have a fatty acid profile which provides for an effective emulsifier.

In view of the above, it would be desirable to produce a food or feed dispersion containing a surfactant which has effective surfactant properties and which is sourced in a manner acceptable to consumers.

### SUMMARY ASPECTS OF THE PRESENT INVENTION

In one aspect, the present invention provides a dispersion comprising (i) a triglyceride continuous phase; (ii) a triglyceride dispersed phase; and (iii) a mono or di ester of glycerol and Moringa oil.

In one aspect, the present invention provides a process for preparing a dispersion comprising (i) a triglyceride continuous phase; (ii) a triglyceride dispersed phase; and (iii) a mono or di ester of glycerol and Moringa oil, the process comprising the steps of

(a) contacting
(i) a first triglyceride; and
(ii) a second triglyceride;
   wherein the first triglyceride and second triglyceride are different
   (b) forming a dispersion wherein the first triglyceride provides a continuous phase and wherein the second triglyceride provides a dispersed phase; and
   (c) contacting the first triglyceride and the second triglyceride either before step (b) or after step (b) with a mono or di ester of glycerol and Moringa oil.

In one aspect, the present invention provides use of a mono or di ester of glycerol and Moringa oil to prepare or stabilise a dispersion comprising (i) a triglyceride continuous phase; and (ii) a triglyceride dispersed phase.

It has been surprisingly found that oil from plants from the genus Moringa may be used in the preparation of mono or di esters of glycerol, commonly known to one skilled in the art as mono and di glycerides, which may be effective surfactant for use in food or feed. The Moringa plant is particularly advantageous as a source of oil to prepare the mono and di glycerides because the plant has been known as a source of edible materials for many years. Therefore the oil obtained from the plant may be regarded as safe for consumption. The use of mono and di glycerides prepared from Moringa oil has not previously been taught.

Moringa is the sole genus in the flowering plant family Moringaceae. The 13 species it contains are from tropical and subtropical climates and range in size from tiny herbs to very large trees. Moringa may therefore be grown in many climates in which cash crops may not currently be cultivated. Moringa cultivation is promoted as a means to combat poverty and malnutrition and the plant grows quickly in many types of environments. The seeds contain 30-50% oil and may produce 100-200 gal/acre/year. Moringa species are drought-resistant and can grow in a wide variety of poor soils, even barren ground, with soil pH between 4.5 and 9.0.

### DETAILED DESCRIPTION

As discussed above, in one aspect, the present invention provides a dispersion comprising (i) a triglyceride continuous phase; (ii) a triglyceride dispersed phase; and (iii) a mono or di ester of glycerol and Moringa oil.

### Moringa

It will be appreciated by one skilled in the art that the term ‘Moringa’ refers to the sole genus in the flowering plant family Moringaceae.

As discussed in Pandey A., Pradheep, K., Gupta, R., Roshini Nayar, E., Bhandari, D. C., (2010) Drumstick tree, Moringa oleifera Lam, a multipurpose potential species in India, Genetic Resources and Crop Evolution, Springer, the genus Moringa Adana, (family Moringaceae) has more than 13 species (Verdcourt 1985), of which two species viz. M. oleifera Lam. (syn. M. pterygosperma Gaertn.) and M. concanensis Nimmo occur in India. M. oleifera (the drumstick tree, horse radish tree, West Indian Ben) is a fast-growing, medium sized and drought-resistant tree distributed in the sub-Himalayan tracts of northern India (Singh et al. 2000; Hsu et al. 2006). The species of Moringa are further discussed in Bennet, R. N., Mellon, F. A., Foidl, N., Pratt, J. H., DuPont, M. S., Perkins, Land Kroon, P. A. (2003) “Profiling gluconsinolates and phenolics in vegetatitve and reproductive tissues of the multi-purpose trees. Moringa oleifera L. (horseradish tree) and Moringa stenopetalia L.” Journal of Agricultural and Food Chemistry 51(12) 3546-3553. M. oleifera (locally called shobhanjana, murungai, soanjna, shajna, sainjna) is considered to be the best known and widely distributed tree species among the genus (Morton 1991; Fuglie 1999). This is the only species in this genus which has been accorded some research and development at the world level.

For completeness, the current known species of the plant family Moringaceae are Moringa arborea Verdc. (Kenya), Moringa borziana Mattel, Moringa concanensis Nimmo, Moringa drouhardii Jum.—Bottle Tree (southwestern Madagascar), Moringa hildebrandtii Engl.—Hildebrandt's Moringa (southwestern Madagascar), Moringa longituba Engl., Moringa oleifera Lam. (syn. M. pterygosperma)—Horseradish Tree (northwestern India), Moringa ovalifolia Dinter & Berger, Moringa peregrina (Forssk.) Fiori, Moringa pygmaea Verdc., Moringa ruspoliana Engl., Moringa rivae (Kenya. Ethiopia and Somalia) and Moringa stenopetala (Baker f.) Cufod.

In a preferred aspect the Moringa is a plant of the species Moringa oleifera.

### Mono or Di Ester of Glycerol and Moringa Oil

The process for making mono or di esters of fatty acids and glycerol, in other words mono and diglycerides and the process for making distilled monoglycerides are well known to the person skilled in the art. For example information can be found in “Emulsifiers in Food Technology”, Blackwell Publishing, edited by R. J. Whitehurst, page 40-58.

Mono- and diglycerides are generally produced by interesterification (glycerolysis) of triglycerides with glycerol, see fig. below:

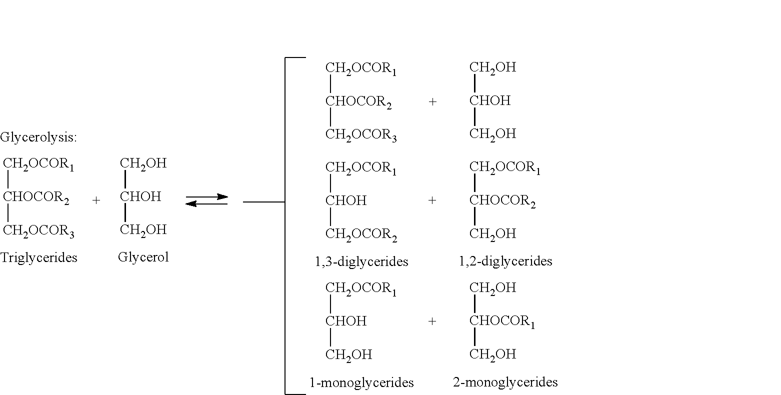

Triglycerides react with glycerol at high temperature (200-250° C.) under alkaline conditions, yielding a mixture of monoglycerides, diglycerides and triglycerides as well as unreacted glycerol. The content of monoglycerides varies typically from 10-60% depending on the glycerol/fat ratio. Alternatively mono- and diglycerides may also be prepared via direct esterification of glycerol with a fatty acid mixture.

If glycerol is removed from the mixture above by e.g. distillation, the resulting mixture of monoglycerides, diglycerides and triglycerides is often sold as a “mono-diglyceride” and used as such. Distilled monoglyceride may be separated from the mono-diglyceride by molecular or short path distillation.

### Dispersion

As discussed above, the dispersion comprises (i) a triglyceride continuous phase; (ii) a triglyceride dispersed phase; and (iii) a mono or di ester of glycerol and Moringa oil. In one aspect the triglyceride continuous phase is a solid triglyceride. In one aspect the triglyceride continuous phase is a liquid triglyceride. In one aspect the triglyceride dispersed phase is a solid triglyceride. In one aspect the triglyceride dispersed phase is a liquid triglyceride.

Preferably the triglyceride continuous phase is selected from hard or soft oils. Preferably the triglyceride continuous phase is selected from palm oil, rape seed oil, sunflower oil, fish oils, soybean oils, coconut oils, ricebran oils, dag oils, beef tallow, allanblackia oils and shea fat.

Preferably the triglyceride dispersed phase is selected from hard or soft oils. Preferably the triglyceride dispersed phase is selected from palm oil, rape seed oil, sunflower oil, fish oils, soybean oils, coconut oils, ricebran oils, dag oils, beef tallow, allanblackia oils and shea fat.

In one aspect the triglyceride dispersed phase is selected from bio-reactor derived algae oils. These materials may be used in dispersion preferably for non-human feed.

It will be appreciated by one skilled in the art that a dispersion which contains a triglyceride does not typically contain water. If water is present and the dispersion contains a dispersed phase and a continuous phase, one of which is triglyceride and one of which is water, this is typically referred to as an emulsion. Thus in one aspect the dispersion is free of water. By free of water it is meant the dispersion contains water in an amount of less than 1 wt. % based on the total dispersion. Preferably the dispersion contains water in an amount of less than 0.8 wt. % based on the total dispersion, such as in an amount of less than 0.6 wt. % based on the total dispersion, such as in an amount of less than 0.5 wt. % based on the total dispersion, such as in an amount of less than 0.4 wt. % based on the total dispersion, such as in an amount of less than 0.3 wt. % based on the total dispersion, such as in an amount of less than 0.2 wt. % based on the total dispersion, such as in an amount of less than 0.1 wt. % based on the total dispersion, such as in an amount of less than 0.05 wt. % based on the total dispersion, such as in an amount of less than 0.02 wt. % based on the total dispersion, such as in an amount of less than 0.01 wt. % based on the total dispersion, such as in an amount of less than 0.001 wt. % based on the total dispersion, such as in an amount of less than 0.0001 wt. % based on the total dispersion.

The dispersion of the present invention may be a food or feed. In one alternative the dispersion of the present invention may be a food additive or food ingredient suitable for addition to a foodstuff to provide a food or feed.

### Usage

The mono or di ester of glycerol and Moringa oil may be provided in the dispersion in the desired amount to achieve the desired function of the mono or di ester of glycerol and Moringa oil. If the dispersion is a food or feed or is added to a food or feed, the mono or di ester of glycerol and Moringa oil may be provided in the dispersion in the desired amount to achieved the desired function of the mono or di ester of glycerol and Moringa oil in the dispersion or in the food or feed to which the dispersion is added.

In one embodiment, mono or di ester of glycerol and Moringa oil is present in the dispersion in an amount of at least about 0.01% w/w based on the total weight of the dispersion. In one embodiment, mono or di ester of glycerol and Moringa oil is present in the dispersion in an amount of at least about 0.02% w/w based on the total weight of the dispersion. In one embodiment, mono or di ester of glycerol and Moringa oil is present in the dispersion in an amount of at least about 0.05% w/w based on the total weight of the dispersion. In one embodiment, mono or di ester of glycerol and Moringa oil is present in the dispersion in an amount of at least about 0.1% w/w based on the total weight of the dispersion. In one embodiment, mono or di ester of glycerol and Moringa oil is present in the dispersion in an amount of at least about 0.2% w/w based on the total weight of the dispersion. In one embodiment, mono or di ester of glycerol and Moringa oil is present in the dispersion in an amount of at least about 0.5% w/w based on the total weight of the dispersion. In one embodiment, mono or di ester of glycerol and Moringa oil is present in the dispersion in an amount of at least about 1.0% w/w based on the total weight of the dispersion. In one embodiment, mono or di ester of glycerol and Moringa oil is present in the dispersion in an amount of at least about 2.0% w/w based on the total weight of the dispersion. In one embodiment, mono or di ester of glycerol and Moringa oil is present in the dispersion in an amount of at least about 3.0% w/w based on the total weight of the dispersion. In one embodiment, mono or di ester of glycerol and Moringa oil is present in the dispersion in an amount of at least about 5.0% w/w based on the total weight of the dispersion. In one embodiment, mono or di ester of glycerol and Moringa oil is present in the dispersion in an amount of at least about 10.0% w/w based on the total weight of the dispersion.

In one embodiment, mono or di ester of glycerol and Moringa oil is present in the food or feed in an amount of at least about 0.01% w/w based on the total weight of the food or feed. In one embodiment, mono or di ester of glycerol and Moringa oil is present in the food or feed in an amount of at least about 0.02% w/w based on the total weight of the food or feed. In one embodiment, mono or di ester of glycerol and Moringa oil is present in the food or feed in an amount of at least about 0.05% w/w based on the total weight of the food or feed. In one embodiment, mono or di ester of glycerol and Moringa oil is present in the food or feed in an amount of at least about 0.1% w/w based on the total weight of the food or feed. In one embodiment, mono or di ester of glycerol and Moringa oil is present in the food or feed in an amount of at least about 0.2% w/w based on the total weight of the food or feed. In one embodiment, mono or di ester of glycerol and Moringa oil is present in the food or feed in an amount of at least about 0.5% w/w based on the total weight of the food or feed. In one embodiment mono or di ester of glycerol and Moringa oil is present in the food or feed in an amount of at least about 1.0% w/w based on the total weight of the food or feed. In one embodiment, mono or di ester of glycerol and Moringa oil is present in the food or feed in an amount of at least about 1.2% w/w based on the total weight of the food or feed. In one embodiment, mono or di ester of glycerol and Moringa oil is present in the food or feed in an amount of at least about 1.5% w/w based on the total weight of the food or feed.

In one embodiment, mono or di ester of glycerol and Moringa oil is present in the food or feed in an amount of from about 0.01 to about 2.0% w/w based on the total weight of the food or feed. In one embodiment, mono or di ester of glycerol and Moringa oil is present in the food or feed in an amount of from about 0.02 to about 2.0% w/w based on the total weight of the food or feed. In one embodiment, mono or di ester of glycerol and Moringa oil is present in the food or feed in an amount of from about 0.05 to about 2.0% w/w based on the total weight of the food or feed. In one embodiment, mono or di ester of glycerol and Moringa oil is present in the food or feed in an amount of from about 0.1 to about 2.0% w/w based on the total weight of the food or feed. In one embodiment, mono or di ester of glycerol and Moringa oil is present in the food or feed in an amount of from about 0.2 to about 2.0% w/w based on the total weight of the food or feed. In one embodiment, mono or di ester of glycerol and Moringa oil is present in the food or feed in an amount of from about 0.5 to about 2.0% w/w based on the total weight of the food or feed. In one embodiment, mono or di ester of glycerol and Moringa oil is present in the food or feed in an amount of from about 0.5 to about 1.5% w/w based on the total weight of the food or feed. In one embodiment, mono or di ester of glycerol and Moringa oil is present in the food or feed in an amount of from about 0.8 to about 1.5% w/w based on the total weight of the food or feed. In one embodiment, mono or di ester of glycerol and Moringa oil is present in the food or feed in an amount of from about 1.0 to about 1.5% w/w based on the total weight of the food or feed. In one embodiment, mono or di ester of glycerol and Moringa oil is present in the food or feed in an amount of from about 1.0 to about 1.2% w/w based on the total weight of the food or feed.

### Food or Feed

In addition to providing a dispersion containing a mono or di ester of glycerol and Moringa oil, the present invention provides a process for preparing the dispersion, in one aspect, the present invention provides a process for preparing a dispersion comprising (i) a triglyceride continuous phase; (ii) a triglyceride dispersed phase; and (iii) a mono or di ester of glycerol and Moringa oil,

the process comprising the steps of
(a) contacting
(i) a first triglyceride; and
(ii) a second triglyceride;
   wherein the first triglyceride and second triglyceride are different
   (b) forming a dispersion wherein the first triglyceride provides a continuous phase and wherein the second triglyceride provides a dispersed phase; and
   (c) contacting the first triglyceride and the second triglyceride either before step (b) or after step (b) with a mono or di ester of glycerol and Moringa oil.

In addition to providing a food or feed containing the dispersion of the present invention, the present invention provides a process for preparing the food or feed containing the dispersion. Thus there is provided a process for preparing a food or feed comprising as defined herein, comprising the steps of contacting (a) a foodstuff and (b) a dispersion comprising (i) a triglyceride continuous phase; (ii) a triglyceride dispersed phase; and (iii) a mono or di ester of glycerol and Moringa oil. In a further aspect, the present invention provides use of a dispersion comprising (i) a triglyceride continuous phase; (ii) a triglyceride dispersed phase; and (iii) a mono or di ester of glycerol and Moringa oil to prepare a food or feed.

According to the present invention, “food” refers to an edible material suitable for human consumption. According to the present invention, “feed” refers to an edible material suitable for non-human animal consumption.

In one aspect the food or feed is a food. In one aspect the food or feed is a feed.

The foodstuff may be solid or liquid. In some cases, the foodstuff may transform during cooking from a solid to a liquid. Furthermore, foodstuffs comprising a combination of liquid and solid components are also encompassed by the present invention.

Examples of foodstuffs in which the present invention may be employed include, but are not limited to tahini(a), ghee, vanaspati, peanut butter and peanut paste, praline and hazelnut spread.

The dispersion of the present invention may be a food selected from, or may be a food additive or food ingredient to be added to a food selected from, nut butters, seed butters, shortenings and liquid bread improvers. In one aspect the nut butter or seed butter is selected from almond butter, cashew butter, hazelnut butter, macadamia nut butter, peanut butter, pecan butter, pistachio butter, walnut butter, pumpkin seed butter, sesame seed butter (tahini), soybean butter and sunflower seed butter.

In one aspect the dispersion is a food suitable for human consumption. Preferably the food is selected from candy bars, whipable fillings, protein drinks, beverage whiteners, milk shake concentrates and savoury flavourings.

In one aspect the dispersion is a feed suitable for animal consumption. Preferably the feed is selected from poultry feed, aqua culture feed, bovine feed and porcine feed. A preferred feed is a feed pellet for fish.

In one embodiment, the food additive or food ingredient may be added to foodstuff selected from the group consisting of spreads, bakery margarine, cake margarine, chocolate, compound chocolate, ice cream, liquid bread improvers. More preferably the foodstuff is selected from chocolate and compound chocolate. In one preferred aspect the foodstuff is selected from whipped frozen desserts. A particularly preferred_whipped frozen dessert is an ice cream.

In one embodiment, the food or feed is selected from a combination of one or more foodstuffs.

### Monoglyceride of Saturated Fatty Acid

The present inventors have further identified that the presence of a monoglyceride of a saturated C16 to C26 fatty acid may be advantageous to the effects achieved in the dispersion of the present invention. Thus in a further aspect, the present invention further provides
a dispersion comprising
   (i) a triglyceride continuous phase;
   (ii) a triglyceride dispersed phase;
   (iii) a mono or di ester of glycerol and Moringa oil; and
   (iv) a monoglyceride of a saturated C16 to C26 fatty acid.
a process for preparing a dispersion comprising
   (i) a triglyceride continuous phase;
   (ii) a triglyceride dispersed phase;
   (iii) a mono or di ester of glycerol and Moringa oil; and
   (iv) a monoglyceride of a saturated C16 to C26 fatty acid
      the process comprising the steps of
      (a) contacting
(i) a first triglyceride; and
(ii) a second triglyceride;
   wherein the first triglyceride and second triglyceride are different
   (b) forming a dispersion wherein the first triglyceride provides a continuous phase and wherein the second triglyceride provides a dispersed phase; and
   (c) contacting the first triglyceride and the second triglyceride either before step (b) or after step (b) with a mono or di ester of glycerol and Moringa oil and with a monoglyceride of a saturated C16 to C26 fatty acid.
use of a mono or di ester of glycerol and Moringa oil and a monoglyceride of a saturated C16 to C26 fatty acid to prepare or stabilise a dispersion comprising (i) a triglyceride continuous phase; and (ii) a triglyceride dispersed phase.

The saturated fatty acid of the monoglyceride may have a carbon chain length of from 16 to 26 carbon atoms. In one aspect the saturated fatty acid of the monoglyceride may have a carbon chain length of from 16 to 24 carbon atoms. In one aspect the saturated fatty acid of the monoglyceride may have a carbon chain length of from 16 to 22 carbon atoms. In one aspect the saturated fatty acid of the monoglyceride may have a carbon chain length of from 18 to 22 carbon atoms. In one aspect the saturated fatty acid is C16 saturated fatty acid. In one aspect the saturated fatty acid is C18 saturated fatty acid. In one aspect the saturated fatty acid is C20 saturated fatty acid. In one aspect the saturated fatty acid is C22 saturated fatty acid. In one aspect the saturated fatty acid is C24 saturated fatty acid. In one aspect the saturated fatty acid is C26 saturated fatty acid.

Preferably the saturated fatty acid of the monoglyceride has a carbon chain length of from 18 to 22 carbon atoms. Preferably the saturated fatty acid of the monoglyceride has a carbon chain length of 18 carbon atoms. Preferably the saturated fatty acid of the monoglyceride has a carbon chain length of 22 carbon atoms.

In one embodiment, the monoglyceride of a saturated C16 to C26 fatty acid is present in the dispersion in an amount of at least about 0.01% w/w based on the total weight of the dispersion. In one embodiment, the monoglyceride of a saturated C16 to C26 fatty acid is present in the dispersion in an amount of at least about 0.02% w/w based on the total weight of the dispersion. In one embodiment, the monoglyceride of a saturated C16 to C26 fatty acid is present in the dispersion in an amount of at least about 0.05% w/w based on the total weight of the dispersion. In one embodiment, the monoglyceride of a saturated C16 to C26 fatty acid is present in the dispersion in an amount of at least about 0.1% w/w based on the total weight of the dispersion. In one embodiment, the monoglyceride of a saturated C16 to C26 fatty acid is present in the dispersion in an amount of at least about 0.2% w/w based on the total weight of the dispersion. In one embodiment, the monoglyceride of a saturated C16 to C26 fatty acid is present in the dispersion in an amount of at least about 0.5% w/w based on the total weight of the dispersion. In one embodiment, the monoglyceride of a saturated C16 to C26 fatty acid is present in the dispersion in an amount of at least about 1.0% w/w based on the total weight of the dispersion. In one embodiment, the monoglyceride of a saturated C16 to C26 fatty acid is present in the dispersion in an amount of at least about 2.0% w/w based on the total weight of the dispersion. In one embodiment, the monoglyceride of a saturated C16 to C26 fatty acid is present in the dispersion in an amount of at least about 3.0% w/w based on the total weight of the dispersion. In one embodiment, the monoglyceride of a saturated C16 to C26 fatty acid is present in the dispersion in an amount of at least about 5.0% w/w based on the total weight of the dispersion. In one embodiment, the monoglyceride of a saturated C16 to C26 fatty acid is present in the dispersion in an amount of at least about 10.0% w/w based on the total weight of the dispersion.

### Polyglycerol Polyricinoleic Acid (PGPR)

The present inventors have identified that the mono or di ester of glycerol and Moringa oil has a significant number of emulsifying properties similar to that of polyglycerol polyricinoleic acid. These are discussed in detail herein. Therefore in aspects of the invention the present emulsifier may be used to replace PGPR in applications where PGPR is typically used. This replacement may be complete replacement or partial replacement. In respect of partial replacement, in that aspect the present invention provides a food or feed as defined herein further comprising polyglycerol polyricinoleic acid. In other words, the present invention provides a food or feed comprising (i) a foodstuff; (ii) an emulsifier composition comprising (a) polyglycerol polyricinoleic acid, and (b) a mono or di ester of glycerol and Moringa oil. Indeed, one skilled in the art will appreciate that the present emulsifier and the PGPR may be provided as an emulsifier composition for use in the preparation of emulsions. Thus, in one aspect, the present invention provides an emulsifier composition comprising (a) polyglycerol polyricinoleic acid; and (b) a mono or di ester of glycerol and Moringa oil.

The use of Moringa monoglycerides in food applications could lead to significant benefits for the customer if these monoglycerides can be used to partially or completely replace polyglycerol polyricinoleic acid (PGPR) based products. Such benefits would likely include; improved production yield (attributed to less down time), allow re-work to occur more easily, and potentially enable the removal of E476 from labelling. It is not clear which of these benefits is most attractive to the customer, but each represents a significant advantage.

Mono or di ester of glycerol and Moringa oil may be prepared at concentrations which are suitable for use in foodstuffs according to recommended daily guidelines.

Alternatively, they may be prepared at higher concentrations and subsequently diluted to a concentration which is suitable for use in foodstuffs according to recommended daily guidelines. Where the composition is prepared at the higher concentration, the composition may comprise (a) polyglycerol polyricinoleic acid; and (b) a mono or di ester of glycerol and Moringa oil in a combined amount of at least 10 wt. %. In one embodiment, the composition comprises (a) polyglycerol polyricinoleic acid; and (b) a mono or di ester of glycerol and Moringa oil in a combined amount of at least 20 wt. %. In one embodiment, the composition comprises (a) polyglycerol polyricinoleic acid; and (b) a mono or di ester of glycerol and Moringa oil in a combined amount of at least 30 wt. %. In one embodiment, the composition comprises (a) polyglycerol polyricinoleic acid; and (b) a mono or di ester of glycerol and Moringa oil in a combined amount of at least 40 wt. %. In one embodiment, the composition comprises (a) polyglycerol polyricinoleic acid; and (b) a mono or di ester of glycerol and Moringa oil in a combined amount of at least 50 wt. %. In one embodiment, the composition comprises (a) polyglycerol polyricinoleic acid; and (b) a mono or di ester of glycerol and Moringa oil in a combined amount of at least 60 wt. %. In one embodiment, the composition comprises (a) polyglycerol polyricinoleic acid; and (b) a mono or di ester of glycerol and Moringa oil in a combined amount of at least 70 wt. %. In one embodiment, the composition comprises (a) polyglycerol polyricinoleic acid; and (b) a mono or di ester of glycerol and Moringa oil in a combined amount of at least 80 wt. %. In one embodiment, the composition comprises (a) polyglycerol polyricinoleic acid; and (b) a mono or di ester of glycerol and Moringa oil in a combined amount of at least 90 wt. %. In one embodiment, the composition consists essentially of (a) polyglycerol polyricinoleic acid; and (b) a mono or di ester of glycerol and Moringa oil.

In this regard, “consisting essentially of” is defined herein as meaning that in addition to the components which are recited, other components may also be present in the composition, provided that the essential characteristics of the composition are not materially affected by their presence.

### Polyglycerols

Polyglycerols are substances consisting of oligomer ethers of glycerol. Polyglycerols are usually prepared from an alkaline polymerisation of glycerol at elevated temperatures.

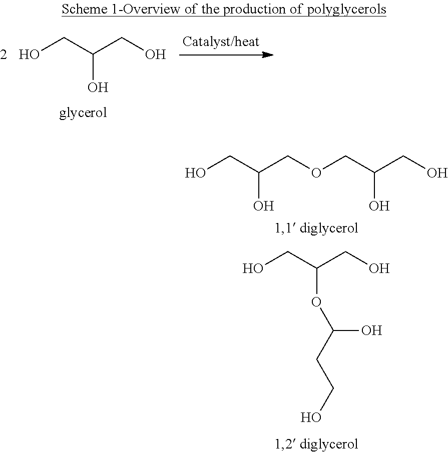 [SMILES: OCC(O)CO ; OCC(O)COCC(O)CO ; OCCC(O)OC(CO)CO]

The processes for making polyglycerols are well known to the person skilled in the art and can be found, for example, in “Emulsifiers in Food Technology”, Blackwell Publishing, edited by R J Whithurst, page 110 to 130.

It will be understood that the degree of polymerisation can vary. It will be understood that polyglycerol is typically a mixture of polyglycerols of varying degrees of polymerisation. In one embodiment, the polyglycerol used to form the polyglycerol ester of a polymerised fatty acid is a mixture of polyglycerols selected from diglycerol, triglycerol, tetraglycerol, pentaglycerol, hexaglycerol, heptaglycerol, octaglycerol, nonaglycerol and decaglycerol. In one preferred embodiment triglycerol is the most abundant polyglycerol in the mixture of polyglycerols. In one preferred embodiment tetraglycerol is the most abundant polyglycerol in the mixture of polyglycerols. In one preferred embodiment the mixture of polyglycerols contains triglycerol in an amount of 30-50 wt. % based on the total weight of polyglycerols and contains tetraglycerol in an amount of 10-30 wt. % based on the total weight of polyglycerols.

In one embodiment, the polyglycerol is considered to be a diglycerol. In one embodiment, the polyglycerol is considered to be a triglycerol. In one embodiment, the polyglycerol is considered to be a tetraglycerol. In one embodiment, the polyglycerol is considered to be a pentaglycerol. In one embodiment, the polyglycerol is considered to be a hexaglycerol. In one embodiment, the polyglycerol is considered to be a heptaglycerol. In one embodiment, the polyglycerol is considered to be an octaglycerol.

In one embodiment, the polyglycerol is considered to be a nonaglycerol. In one embodiment, the polyglycerol is considered to be a decaglycerol.

Preferably the polyglycerol is considered to be a triglycerol. Preferably the polyglycerol is considered to be a tetraglycerol.

In one embodiment, the polyglycerol moiety shall be composed of not less than 75% of di-, tri- and tetraglycerols and shall contain no more than 10% of polyglycerols equal to or higher than heptaglycerol.

Polyglycerols may be linear, branched or cyclic in structure. Typically, all three types of polyglycerol structure are present in the composition of the present invention.

### Fatty Acids

Fatty acids are well known in the art. They typically comprise an “acid moiety” and a “fatty chain”. The properties of the fatty acid can vary depending on the length of the fatty chain, its degree of saturation, and the presence of any substituents on the fatty chain. Examples of fatty acids are palmitic acid, stearic acid, oleic acid, and ricinoleic acid.

The fatty acid used according to this aspect of the present invention is ricinoleic acid.

Ricinoleic acid is a chiral molecule. Two steric representations of ricinoleic acid are given below:

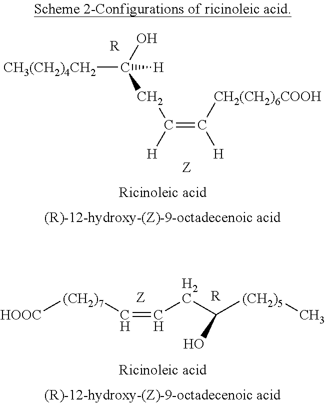

The ricinoleic acid used in the present invention may be prepared by any suitable means known to the person skilled in the art. Typically, fatty acids are produced from a parent oil via hydrolyzation and distillation.

### BRIEF DESCRIPTION OF FIGURES

FIGS. 1 to 7 show graphs.

### EXAMPLES

The present invention will now be defined with reference to the following non-limiting examples.

### Example 1

### Preparation of Moringa Monoglycerides

The Moringa monoglyceride and distilled Moringa monoglyceride were prepared in several batches in accordance with the processes described below.

### 2472/173: Mono-Diglyceride Based on Moringa Oil, Interesterification.

### (Mono-diglyceride 173; Moringa Mono-diglyceride 73; Moringa 173; MM 173)

Refined moringa oil (Code: 126089, Batch Nr: DEO5040243, EO Ref: SO4903823/1, from Earth Oil Plantations Limited). 2550 g. The moringa oil was extracted from Moringa oleifera (also known as Moringa pterygosperma).

### Glycerol 625 g.

1.300 g 50% solution of NaOH.

Above ingredients were charged to a 5 L 3-necked round bottomed flask, with mechanical stirring, heating mantel with temperature control, nitrogen blanketing, condenser, in a set-up analogous to the below example:

The temperature was raised to 240° C. under stirring and nitrogen blanketing. The mixture was heated at 240° C. until it became clear. When clear, the mixture was heated for further 30 min.

The mixture was then neutralised with 1.25 g H₃PO₄ (85%) at 240° C. After neutralisation the mixture was cooled to about 90° C.

The mixture was deodorised in order to remove the free glycerol. The set-up around the 3-necked flask was therefore changed to look like the below example of a deodorisation set-up:

Water vapours were introduced to the mixture via a glass tube at the bottom of the 3 necked flask below surface level of the mixture, a cold trap cooled by acetone/CO₂ bath was used and connected to a vacuum pump.

At 90° C. full vacuum (<0.5 mm Hg) was supplied to the set-up from the vacuum pump. This causes thorough mixing of the product mixture. Then the mixture was heated to 140° C. and kept at this temperature for 30 min. Water vapours were passing through the mixture thereby removing free glycerol which was condensed on the cold trap and collected in the receiver flask.

After 30 min the product was cooled to 90° and pressure equalised with nitrogen.

Optionally the filtered mono-diglyceride can be protected with antioxidants if the mono-diglyceride is the end product. Antioxidants were added and the mixture stirred for 15-30 min under nitrogen blanketing at 80-90° C.

Yield 2870 g.

The mono-diglyceride was filtered through filteraid (Clarcell) and paper filter (AGF 165-110).

### 2472/191: Distilled Monoglyceride Based on Moringa Oil.

### (Mono-Diglyceride 191; Moringa Mono-Diglyceride 191; Moringa 191; MM 191)

### Mono-diglyceride (2472/173) 2480 g.

The mono-diglyceride was distilled on a short path distillation apparatus.

The distillation temperature was 210° C.
Reservoir temp. before heated surface 85° C.

### Condenser was 85° C.

Rotor speed 302 rpm.
Pressure: 1×10⁻³ mBar

### Distillate 1373 g

### Residue 1107 g

### Time 212 min.

### Flow: 701 g/h

The distillate was added antioxidant Grindox 349 0.68 g.

Analysis of the distilled monoglyceride determined by GC:

TABLE 1
composition of monoglyceride based on moringa oil

| | % |
|---|---|
| Glycerol | 0.76 |
| Diglycerol | 0.07 |
| Monoglyceride | 91.15 |
| Diglyceride | 7.75 |
| Triglyceride | 0.00 |

The fatty acid composition of both the starting material, moringa oil, and the resulting monoglyceride was also analysed:

TABLE 2
Fatty acid composition of moringa oil and the resulting monoglyceride.

| | Triglyceride | Monoglyceride |
|---|---|---|
| | (moringa oil) | 2472/191 |
| C12 | 0.2 | <0.1 |
| C14 | 0.1 | 0.1 |
| C15 | <0.1 | <0.1 |
| C16 | 5.9 | 6.5 |
| C16:1 | 1.8 | 1.8 |
| C18 | 5.5 | 5.8 |
| C18:1 | 71.8 | 71.2 |
| C18:2 | 1.6 | 1.5 |
| C18:3 | 0 | 0.3 |
| C20 | 3.3 | 3.4 |
| C20:1 | 1.9 | 1.9 |
| C22 | 6.3 | 6.0 |
| C24 | 1.0 | 0.8 |

This analysis was done in order to confirm that the fatty acid composition of the monoglyceride had not changed too much from the starting material.

Moringa oil contains 10-12% of saturated fatty acids above C18. In order to keep these high melting fatty acids in the distilled monoglyceride the distillation temperature had to be chosen sufficiently high such that these at least were distilled. As can be seen from the above table this was accomplished. Transferring the highest boiling monoglyceride components however results in the monoglyceride as such having a higher content of diglyceride than is usually seen with distilled monoglycerides, but that is merely a consequence of the broad fatty acid composition in the moringa oil, and that the heavier monoglycerides were prioritised due to their also higher melting points.

### 2559/102: Mono-Diglyceride Based on Moringa Oil, Interesterification.

### (Mono-diglyceride 102; Moringa Mono-diglyceride 102; Moringa 102; MM 102)

Refined moringa oil (Code: 126089, Batch Nr: DEO5040243, EO Ref: SO4903823/1, from Earth Oil Plantations Limited). 2072 g.

### Glycerol 518 g

1.082 g 50% solution of NaOH

The experiment was carried out as for above interesterification (2472/173).

After the interesterification, the mixture was neutralised with 1.04 g H₃PO₄ (85%) at 240° C. After neutralisation the mixture was cooled to about 90° C. and the mixture was deodorised and filtered as for above interesterification (2472/173).

Yield: 2313 g.

Analysis of mono-diglyceride:

TABLE 3
Composition of mono-diglyceride based on moringa oil

| | % |
|---|---|
| Glycerol | 0.11 |
| Diglycerol | 0.05 |
| Free fatty acids | 0.2 |
| Monoglyceride | 53.16 |
| Diglyceride | 42.05 |
| Triglyceride | 4.39 |

### 2559/103: Mono-Diglyceride Based on Moringa Oil, Interesterification

(Mono-diglyceride 103; Moringa Mono-diglyceride 103; Moringa 103; MM 103) (repetition of 2559/102)

Refined moringa oil (Code: 126089, Batch Nr: DEO5040243, EO Ref: SO4903823/1, from Earth Oil Plantations Limited). 2146 g.

### Glycerol 537 g

1.110 g 50% solution of NaOH

The experiment was carried out as for above interesterification (2472/173).

After the interesterification, the mixture was neutralised with 1.07 g H₃PO₄ (85%) at 240° C. After neutralisation the mixture was cooled to about 90° C. and the mixture was deodorised and filtered as for above interesterification (2472/173).

Yield: 2412 g.

Analysis of mono-diglyceride:

TABLE 4
Composition of mono-diglyceride based on moringa oil

| | % |
|---|---|
| Glycerol | 0.16 |
| Diglycerol | 0.02 |
| Free fatty acids | 0.3 |
| Monoglyceride | 54.85 |
| Diglyceride | 39.59 |
| Triglyceride | 5.06 |

### 2559/104: Distilled Monoglyceride Based on Moringa Oil.

### (Mono-diglyceride 104; Moringa Mono-diglyceride 104; Moringa 104; MM 104)

The mono-diglyceride was distilled on a short path distillation apparatus as above (2472/191).
Mono-diglyceride (2559/102)+(2559/103) were both distilled.
The distillation temperature was 200-210° C.
Reservoir temp. before heated surface 85° C.

### Condenser was 90° C.

Rotor speed 297 rpm.
Pressure: 4-5×10⁻³ mBar

### Distillate 2245 g

### Residue 1819 g

### Time 360 min.

### Flow: 677 g/h

Analysis of distilled monoglyceride determined by GC:

TABLE 5
Composition of monoglyceride based on moringa oil

| | % |
|---|---|
| Glycerol | 1.27 |
| Diglycerol | 0.08 |
| Free fatty acids | 0.4 |
| Monoglyceride | 82.55 |
| Diglyceride | 15.67 |
| Triglyceride | 0.02 |

2559/105: Distilled Monoglyceride Above Based on Moringa Oil with Added Antioxidant.

### (Mono-diglyceride 105; Moringa Mono-diglyceride 105; Moringa 105; MM 105)

2559/104: 2245 g

### Grindox 349: 1.12 g

### 2559/132: Distilled Monoglyceride Based on Moringa Oil.

### (Mono-diglyceride 132; Moringa Mono-diglyceride 132; Moringa 132; MM 132)

Mono-diglyceride prepared analogously to above mono-diglycerides (2472/173) and with the following analysis was used as raw material for the distillation.

TABLE 6
Composition of mono-diglyceride used as raw material for distillation.

| | % |
|---|---|
| Glycerol | 0.16 |
| Diglycerol | 0.13 |
| Free fatty acids | 0.2 |
| Monoglyceride | 55.39 |
| Diglyceride | 39.50 |
| Triglyceride | 4.65 |

The mono-diglyceride was distilled on a short path distillation apparatus as above (2472/191).

The distillation temperature was 210′C.
Reservoir temp. before heated surface 85′C,

### Condenser was 85° C.

Rotor speed 297 rpm,
Pressure: 1-2×10⁻³ mBar

### Distillate 1506 g

### Residue 1092 g

### Time 211 min.

### Flow: 739 g/h

Analysis of distilled monoglyceride determined by GC:

TABLE 7
Composition of monoglyceride based on moringa oil

| | % |
|---|---|
| Glycerol | 0.88 |
| Diglycerol | 0.15 |
| Free fatty acids | 0.2 |
| Monoglyceride | 86.92 |
| Diglyceride | 11.80 |
| Triglyceride | 0.03 |

### 2559/134: Distilled Monoglyceride Based on Moringa Oil.

### (Mono-diglyceride 134; Moringa Mono-diglyceride 134; Moringa 134; MM 134)

Mono-diglyceride prepared analogously to above mono-diglycerides (2472/173) and with the following analysis was used as raw material for the distillation.

TABLE 8
Composition of mono-diglyceride used as raw material for distillation.

| | % |
|---|---|
| Glycerol | 0.49 |
| Diglycerol | 0.11 |
| Free fatty acids | 0.2 |
| Monoglyceride | 54.51 |
| Diglyceride | 39.78 |
| Triglyceride | 4.92 |

The mono-diglyceride was distilled on a short path distillation apparatus as above (2472/191),

The distillation temperature was 185′C.
Reservoir temp. before heated surface 85° C.

### Condenser was 85° C.

Rotor speed 290 rpm.
Pressure: 1-2×10⁻³ mBar

### Distillate 1407 g

### Residue 1444 g

### Time 223 min.

### Flow: 767 g/h

Analysis of distilled monoglyceride determined by GC:

TABLE 9
Composition of monoglyceride based on moringa oil.

| | % |
|---|---|
| Glycerol | 0.52 |
| Diglycerol | 0.22 |
| Free fatty acids | 0.2 |
| Monoglyceride | 97.98 |
| Diglyceride | 1.06 |
| Triglyceride | 0.02 |

A summary of the analyses of samples 2559/132 and 2559/134 is given in Table 10 below.

TABLE 10

| | Monoglyceride | Monoglyceride | |
|---|---|---|---|
| | 2559/132 | 2559/134 | Triglyceride |
| Distillation ° C. | 210° C. | 185° C. | starting material |
| GL | 0.88 | 0.52 | |
| DIGL | 0.15 | 0.22 | |
| FFA | 0.2 | 0.2 | |
| MONO | 86.92 | 97.95 | |
| DI | 11.80 | 1.06 | |
| TRI | 0.03 | 0.02 | |
| C12 | <0.1 | <0.1 | 0.2 |
| C14 | 0.1 | 0.1 | 0.1 |
| C16 | 6.3 | 6.4 | 5.9 |
| C16:1 | 1.9 | 1.9 | 1.8 |
| C17 | 0.1 | 0.1 | 0.1 |
| C18 | 5.5 | 5.7 | 5.5 |
| C18:1 | 72.6 | 75.3 | 71.8 |
| C18:2 | 1.5 | 1.5 | 1.6 |
| C18:3 | 0.2 | 0.2 | 0.0 |
| C20 | 3.2 | 2.9 | 3.3 |
| C20:1 | 1.8 | 1.7 | 1.9 |
| C20:u | 0.2 | 0.2 | 0.1 |
| C21 | <0.1 | 0.0 | |
| C22 | 5.8 | 3.6 | 6.3 |
| C22:1 | 0.1 | 0.0 | 0.1 |
| C23 | <0.1 | <0.1 | 1.0 |
| C24 | 0.8 | 0.3 | 0.1 |

### 2461/206: Mono-Diglyceride Based on Moringa Oil, Interesterification.

Refined moringa oil (Code: 126089, Batch Nr: DEO5040243, EO Ref: SO4903823/1, from Earth Oil Plantations Limited). 3000 g.

### Glycerol 750 g

1.08 g 50% solution of NaOH

The experiment was carried out as for above interesterification (2472/173).

After the interesterification, the mixture was neutralised with 5.65 g H₃PO₄ (10%) in glycerol at 240° C. After neutralisation the mixture was cooled to about 90° C. and the mixture was deodorised and filtered as for above interesterification (2472/173).

Yield: 3751 g.

Analysis of mono-diglyceride:

TABLE 3
Composition of mono-diglyceride based on moringa oil

| | % |
|---|---|
| Glycerol | 0.2 |
| Diglycerol | <0.1 |
| Free fatty acids | 0.2 |
| Monoglyceride | 54.0 |
| Diglyceride | 40.5 |
| Triglyceride | 5.1 |

2461/207: Mono-Diglyceride Based on Moringa Oil, Interestercation (repetition of 2461/206)

Refined moringa oil (Code: 126089, Batch Nr: DEO5040243, EO Ref: SO4903823/1, from Earth Oil Plantations Limited). 3000 g.

### Glycerol 750 g

1.08 g 50% solution of NaOH

The experiment was carried out as for above interesterification (2472/173).

After the interesterification, the mixture was neutralised with 5.65 g H₃PO₄ (10%) in glycerol at 240° C. After neutralisation the mixture was cooled to about 90° C. and the mixture was deodorised and filtered as for above interesterification (2472/173).

Yield: 3751 g.

Analysis of mono-diglyceride:

TABLE 4
Composition of mono-diglyceride based on moringa oil

| | % |
|---|---|
| Glycerol | 0.5 |
| Diglycerol | <0.1 |
| Free fatty acids | 0.3 |
| Monoglyceride | 52.0 |
| Diglyceride | 41.9 |
| Triglyceride | 5.3 |

### 2461/208: Distilled Monoglyceride Based on Moringa Oil.

The mono-diglycerides 2461/206+2461/208 was distilled on a short path distillation apparatus as above (2472/191).

The distillation temperature was 210° C.
Reservoir temp. before heated surface 85° C.

### Condenser was 80° C.

Rotor speed 300 rpm,
Pressure: 2×10⁻³ mBar

### Distillate 3750 g

### Residue 2711 g

### Time 540 min.

### Flow: 718 g/h

Analysis of distilled monoglyceride determined by GC:

TABLE 5
Composition of monoglyceride based on moringa oil

| | % |
|---|---|
| Glycerol | 1.2 |
| Diglycerol | 0.1 |
| Free fatty acids | 0.1 |
| Monoglyceride | 83.5 |
| Diglyceride | 15.2 |
| Triglyceride | 0.1 |

The distilled monoglyceride was protected with antioxidant:

### Grindox 349: 1.87 g

### Example 2

### Preparation and Testing of Peanut Butters

### Experimental

### Procedure

The following equipment was used:

Scale; Steam bath; Chilled water bath; 5 Quart stand mixer; Water jacketed mixing bowl with connections to water bath; Mixing paddle; Tubing; Metal container; 250 ml beaker; Rubber spatula; and Infrared thermometer.

### Set-up:

Connect tubing from chilled water bath to mixing bowl as follows, Place the inflow of the water bath to the top connector on the mixing bowl and outflow of the water bath to the bottom connector on the mixing bowl. Set temperature of the water bath to 120° C. Allow water bath to come to temperature before adding mixture to bowl.

### Processing:

Place peanut butter paste in metal container and place on a steam bath bringing the temperature of the peanut butter paste to 82° C. Add stabilizer, salt and sugar to peanut butter paste.

A range of stabilisers were tested both at dosages of 1.5 wt % and 3%. Stabilisers were used individually and in combination.

### Samples Containing 1.5% Stabiliser Had the Following Composition

| Ingredients | | Batch Size |
|---|---|---|
| Peanut Butter Paste | 90.50% | 905 g |
| Stabilizer | 1.50% | 15 g |
| Sugar | 6.50% | 65 g |
| Salt | 1.50% | 15 g |
| | | 1000 g |

### Samples Containing 3.0% Stabiliser Had the Following Composition

| Ingredients | | Batch Size |
|---|---|---|
| Peanut Butter Paste | 89.00% | 890 g |
| Stabilizer | 3.00% | 30 g |
| Sugar | 6.50% | 65 g |
| Salt | 1.50% | 15 g |
| | | 1000 g |

Continue to mix at 82° C. until formula has been thoroughly mixed, 5 to 10 minutes. Pour into mixing bowl and mix on low. Cool mixture to 33-35° C., pour into 2 jars and attach lids. Store sample at 20° C. Evaluate samples at 48 hours and 2 weeks.

### Sample Evaluation:

At 48 hours and 3 weeks, the product is evaluated. Evaluation may include the following characteristics:

Cone penetrometer—Readings should be taken from both the middle and the side. Drop probe and measure distance versus time.

Appearance in jar—Note abnormalities such as product pulling away from jar, cracking
Appearance of surface—Note product shine or dullness
Spread on cardboard—Note the consistency of product
Mouth feel—Note the texture of product in mouth
Taste—Note flavor release and overall taste

Samples were measured for firmness by way of a penetrometer with cone probe and 50 g weight. Drop lever was pressed for 5 seconds and the distance (mm) traveled by probe was measured. Maximum distance was 30.5 mm.

Appearance of peanut butter in jar was observed, noting shininess or dullness, oiling off, cracking and pull away. Consistency and texture were also observed by spreading peanut butter on cardboard, noting ease of spread and oiling off.

### DSC:

Differential scanning calorimetry (DSC) was performed in duplicate. The concentration of stabilizer in vegetable oil (peanut oil) was 3% for control PS105, and thereafter stabilizer addition was 6% total. Approximately 2-5 mg of sample was weighed into a pan.

i) heat samples from 0° to 80° C. at a rate of 5° C./min
ii) cool down from 80° to 0° C. at a rate of 5° C./min
iii) heat the sample again from 0° to 80° C. at a rate of 5° C./min

### Rheology:

All rheological experiments were carried out on a Haake RS 150 controlled stress rheometer, where small angle oscillatory measurements were carried out. The samples (based on peanut oil and the control PS 105 at 3%, then all subsequent samples are at total of 6% dose) were first placed in a microwave and heated for a total of two minutes at 800 W to take the temperature above 90′C. and thereby eliminate all previous crystal history. The hot fluid sample was now added to the rheometer and the plates closed to gap, and the measurement begun. The running conditions were as follows; a temperature ramp from 85 to 25° C. was run at a cooling rate of 1° C. per minute, the strain was held constant at 0.004+/−0.001, The gap used was 0.5 mm, and the frequency of oscillation as 0.5 Hz—all well within the linear viscoelastic region. The plates used were both 35 mm parallel serrated plates, and 120 data points were recorded in a linear data collection mode during the measurement.

### Results

| | Use | Penetrometer | |
|---|---|---|---|
| Stabilizer | Level | (mm) | Notes |
| PS 105 | 1.50% | 22.10 | Standard peanut butter |
| PGPR 90 | 1.50% | 30.50 | Setimentation of solids |
| Moringa 132 | 1.50% | 30.50 | Liquid |
| Moringa 105 | 1.50% | 30.50 | Liquid |
| PS 105 + | 1.50% | 30.50 | Soft set, shiny |
| Moringa 132 | | | |
| (50/50) | | | |
| PS 105 + PGPR | 1.50% | 30.50 | Soft set, air bubbles trapped |
| 90 (50/50) | | | on top |
| PS 105 | 3.00% | 14.00 | Appeared like standard peanut |
| | | | butter but very firm |
| PGPR 90 | 3.00% | 30.50 | Setimentation of solids |
| Moringa 132 | 3.00% | 30.50 | Set |
| Moringa 105 | 3.00% | 30.50 | Soft set |
| PS 105 + | 3.00% | 25.80 | Similar to PS 105 at 1.5% |
| Moringa 132 | | | |
| (50/50) | | | |
| PS 105 + PGPR | 3.00% | 29.00 | Soft set, air bubbles trapped |
| 90 (50/50) | | on top | |

GRINDSTED ® PS 105 is a triglyceride prepared from Kosher approved blend of edible, refined, fully hydrogenated rapeseed, cottonseed and soybean oils, available from Danisco A/S, Denmark
GRINDSTED ® PGPR 90 is a polyglycerol polyricinoleic acid available from Danisco A/S, Denmark. It is polyglycerol ester of polycondensed fatty acids from castor oil.

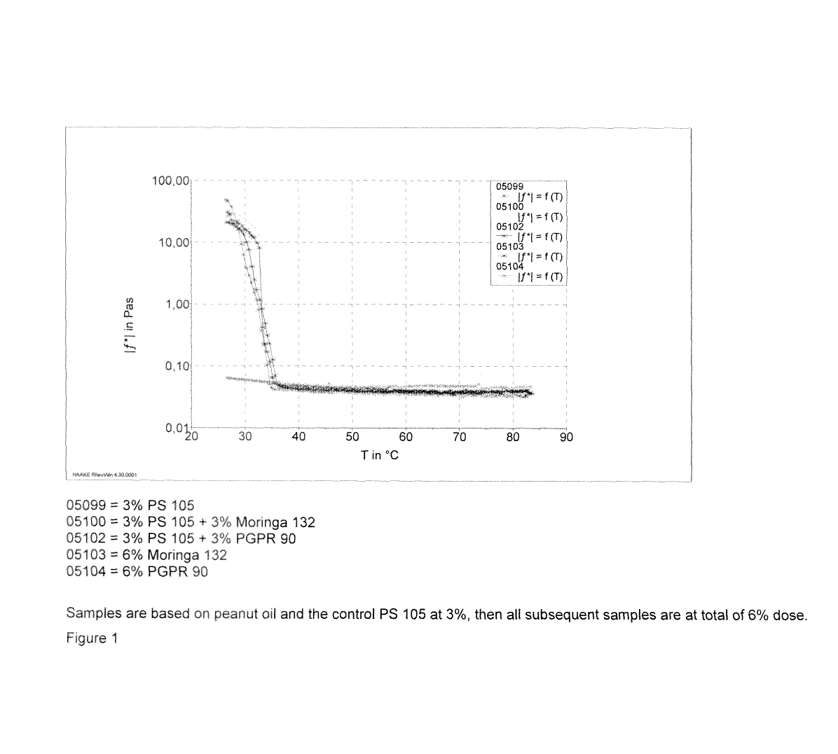

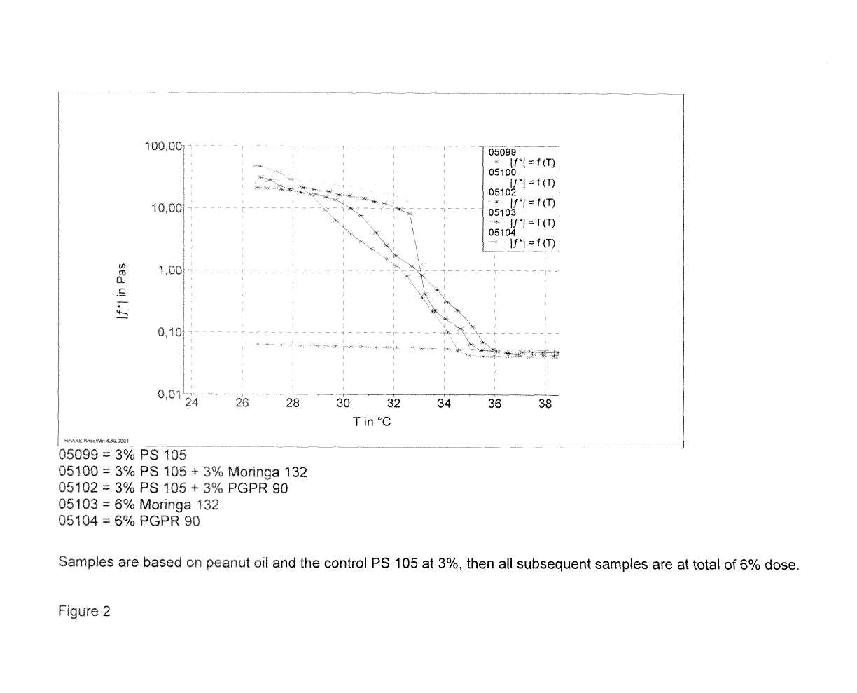

The results of the rheology determination show that Moringa and PGPR are able to enhance crystallisation kinetics of the second stabilizer (PS 105), but also Moringa is able to induce onset of viscosity (in other words—crystallisation) and are shown in FIGS. 1 and 2.

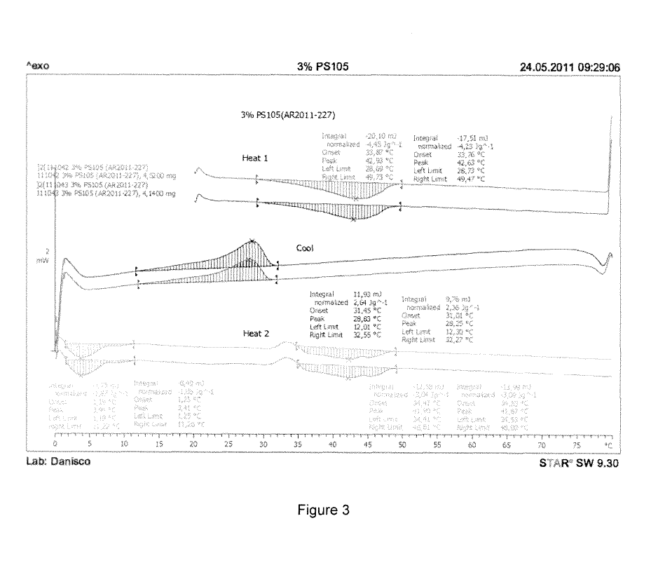

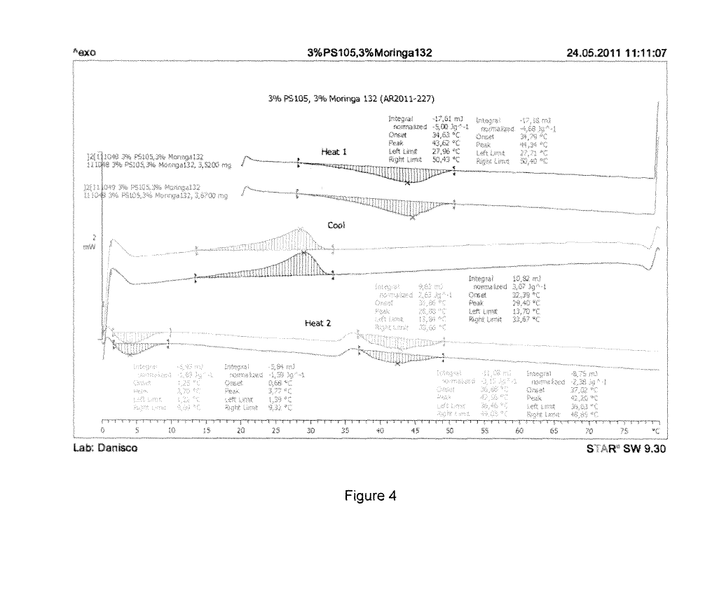

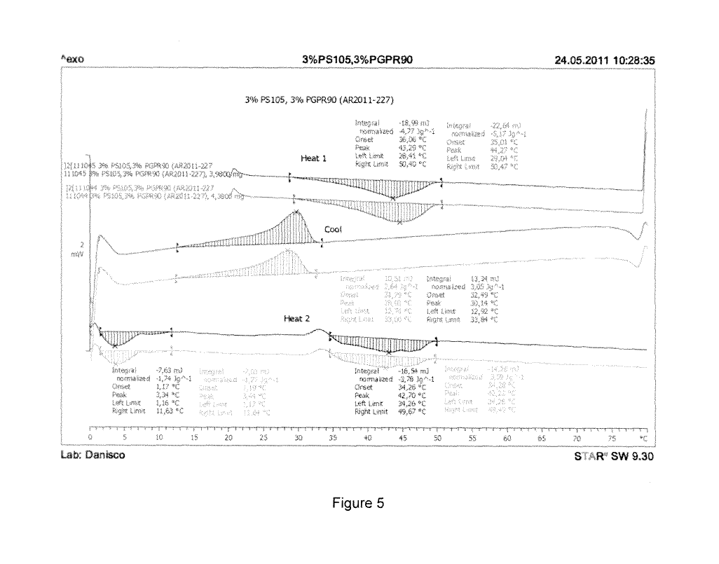

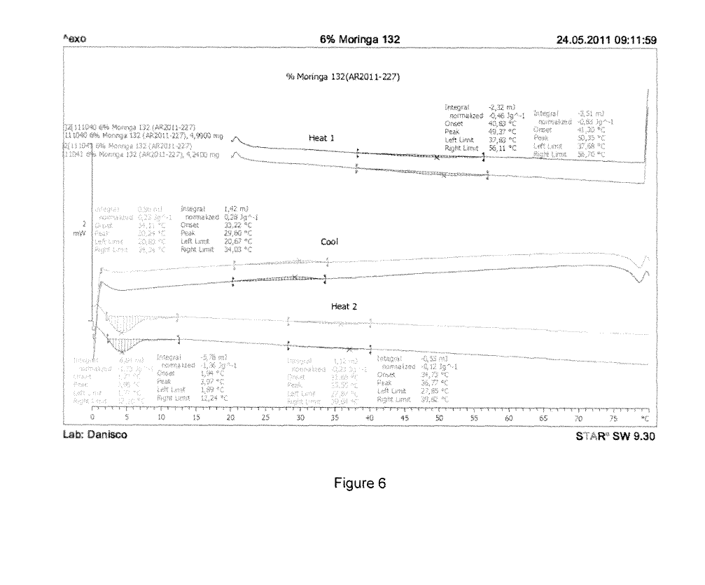

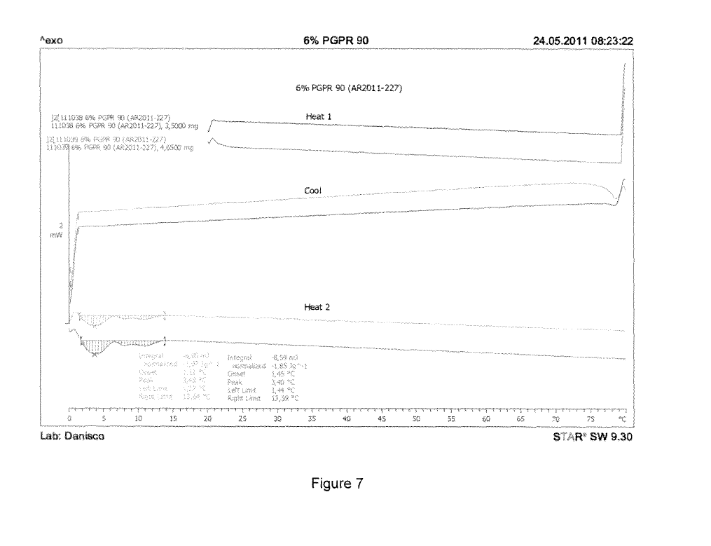

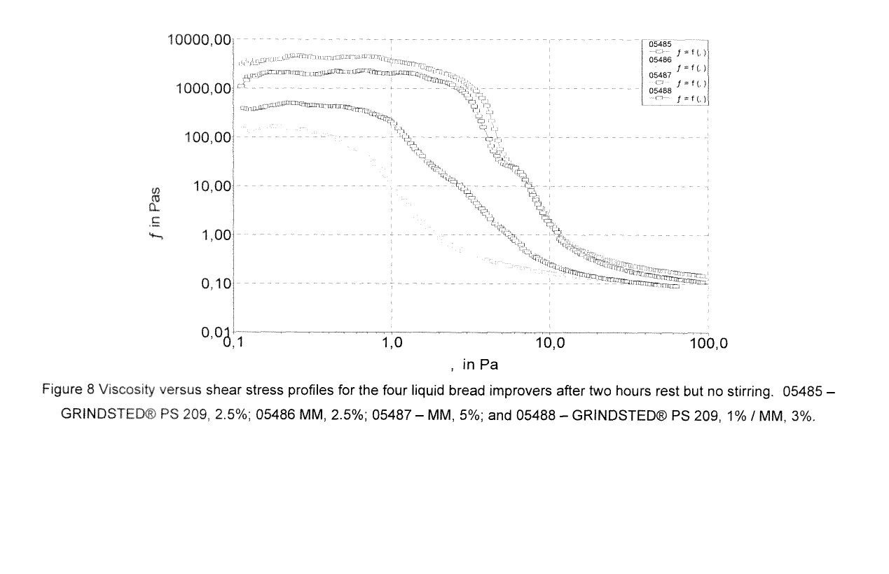

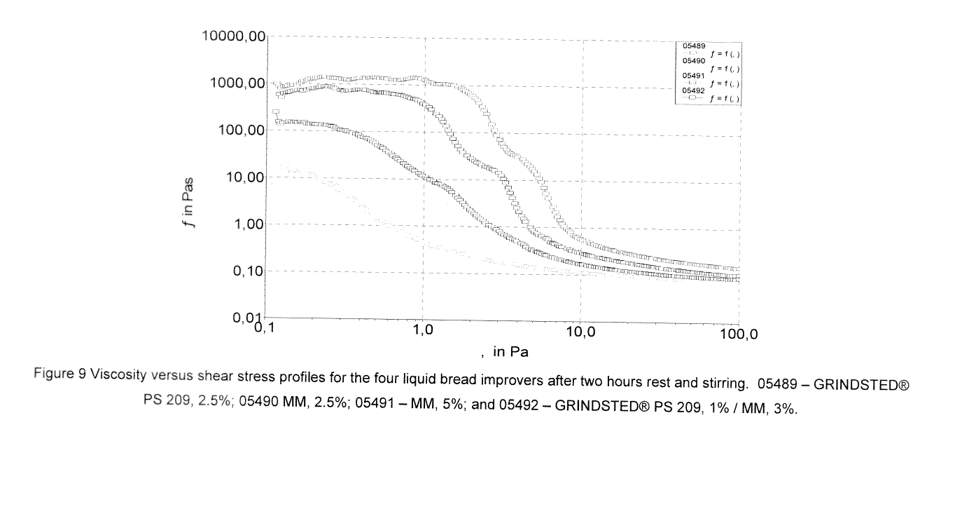

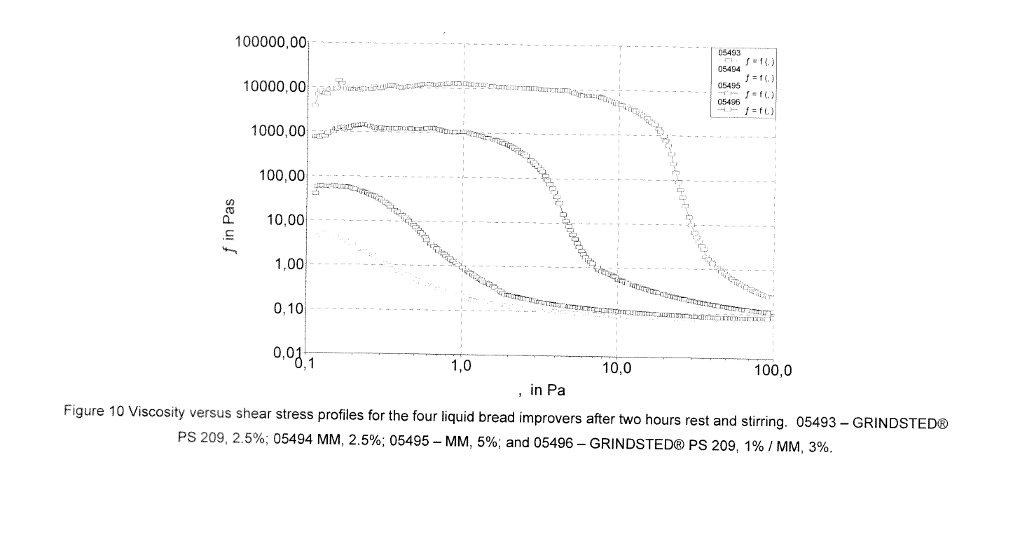

The results of the DSC is shown in FIGS. 3 to 7,

### Example 3

### Preparation and Testing of Liquid Bread Improvers

### Materials & Methods

The recipes of the liquid bread improvers tested are given in Table 11, where sample 51 is a reference with GRINDSTED® PS 209, samples 52 and 53 have MM dosed in at 2.5 and 5% respectively and sample 54 contains a mixture with GRINDSTED® PS 209 at 1% and MM at 3% levels. GRINDSTED® PS 209 is a blend of mono- and triglycerides based on edible, fully hydrogenated rapeseed oil.

TABLE 11
Recipe for the liquid bread improvers tested.
Ingredients in %

| | | | | |
|---|---|---|---|---|
| Ingredient Name | 51 | 52 | 53 | 54 |

Water phase

| | | | | |
|---|---|---|---|---|
| Ascorbic acid | 3,000 | 3,000 | 3,000 | 3,000 |
| Grindamyl H 121 | 4,500 | 4,500 | 4,500 | 4,500 |
| Water phase total | 7,500 | 7,500 | 7,500 | 7,500 |

Fat phase

| | | | | |
|---|---|---|---|---|
| Fat blend | | | | |
| Rapeseed oil | 100,000 | 100,000 | 100,000 | 100,000 |
| Fat blend total | 100,000 | 100,000 | 100,000 | 100,000 |

Other fat ingredients

| | | | | |
|---|---|---|---|---|
| GRINDSTED ® PS | 2,500 | | | 1,000 |
| 209 Fat/Emulsifier Blend | | | | |
| Distilled Monoglyceride, | | 2,500 | 5,000 | 3,000 |
| Moringa Oil (Lot | | | | |
| 2461-208) | | | | |
| Other fat ingredients total | 2,500 | 2,500 | 5,000 | 4,000 |
| Fat phase total | 92,500 | 92,500 | 92,500 | 92,500 |
| RECIPE total (calc. | 100,000 | 100,000 | 100,000 | 100,000 |
| batchsize) | | | | |

The procedure for running these recipes is given as follow:

### Fat Phase:

1. Weigh out emulsifiers and oil/fat in the same container

### 2. Heat to 80° C.

3. Stir fat phase until mixed well
4. Cool fat phase to 60° C.

### Samples:

1 Fill into 4×50 g containers, rest for 2 hours and measure
2. Fill into steel containers and leave to rest for 2 hours, stir for 10 minutes, fill into 4×50 g containers and measure
3. Stir for 5 minutes while adding dry ingredients, fill into 4×50 g containers and measure

The running conditions on the pilot plant are given by Table 12.

TABLE 12
Plant running conditions for the liquid bread improver samples tested.
Pilot Plant

| Processing (3-tube lab perfector): | 51 | 52 | 53 | 54 |
|---|---|---|---|---|
| Oil phase temperature | 55 | 55 | 55 | 55 |
| Water phase temperature | | | | |
| Emulsion temperature | 55 | 55 | 55 | 55 |
| Centrifugal pump | Auto | Auto | Auto | Auto |
| Capacity high pressure pump | 50 | 50 | 50 | 50 |
| Cooling (NH3) tube 1: | −10 | −10 | −10 | −10 |
| Cooling (NH3) tube 2: | −10 | −10 | −10 | −10 |
| Rpm tube 1: | 950 | 950 | 950 | 950 |
| Rpm tube 2: | 950 | 950 | 950 | 950 |

The samples were measured under three separate conditions to obtain their viscosity versus shear stress profiles using a controlled stress rheometer (Haake RS 150). The first measurement took place on unstirred samples, which had been allowed to stand for two hours. The second set of measurements took place on stirred samples after standing for two hours and the third set was done on the stirred sample to which powders had been added. The first two sets of measurements were performed with a cup-bob geometry of 20 mm diameter and run over a stress ramp from 0.1 to 100 Pa over a time range of 240 seconds. 200 data points were gathered in a logarithmic distribution at 23° C. The samples with the powder had the same running conditions, but the measurement geometry was changed to a serrated set of parallel plates due to the powder inclusion.

### RESULTS & DISCUSSION

The results given in FIG. 8 show the viscosity versus shear stress profiles for the four samples tested after the samples have been allowed to stand at rest after production. The samples have not been stirred. In each case we see the characteristic pseudoplastic behaviour, a low stress Newtonian like plateau followed by a reduction in viscosity after a certain critical stress has been reached. The sample with GRINDSTED® PS 209 alone, shows the greatest viscosity and demonstrates a profile that has been seen before both in terms of profile shape and viscosity value. The two samples with MM at 2.5% and 5% concentration follow the expected concentration gradient, but are considerably less viscous than the sample with GRINDSTED® PS 209 by up to and beyond an order of magnitude. The relative size of the low stress Newtonian plateau similarly is influenced by concentration, stretching longer in the MM sample of highest concentration. The last sample where GRINDSTED® PS 209 at 1% is combined with MM at 3% is very similar in profile shape to that of GRINDSTED® PS 209 alone, but is slightly lower in viscosity.

After the samples have been allowed to rest for two hours they are then subject to a stirring process to break the primary bonds of the fat structure and to initiate the secondary bonds. The viscosity—shear stress profiles for this are given in FIG. 9.

After stirring all samples have reduced in viscosity and the similarity in profile shape is still evident between GRINDSTED® PS 209 alone and in combination with MM

The data given in FIG. 10 shows the viscosity versus shear rate profiles for the samples after stirring and with powders added. Visually, the samples appeared white and opaque, but the samples with MM alone, especially at 2.5% dosage were very low in viscosity. As is given in FIG. 10 the visual evaluation was also able to pick out the most and least viscous correctly. The viscosity profiles for MM samples at 2.5% or 5% show a low degree of stability against increasing stress.

This leads to the suggestion that MM may be able to be used in combination with other ingredients to give specific functionality.

### CONCLUSION

Monoglycerides of Moringa (MM) were incorporated into liquid bread improver systems at 2.5% and 5.0% in isolation and in combination with GRINDSTED® PS 209 at 1.0% and MM at 3.0%. This was compared against the reference sample of GRINDSTED® PS 209 at 2.5%. The systems were measured after two hours rest (no stirring); after two hours and stirring, and after addition of powders. In each case the lowest viscosity could be attributed to the MM samples in order of concentration. Combined with GRINDSTED® PS 209, the MM gave a profile that was similar to the reference in the non-stirred sample, but lower viscosity thereafter. The power containing samples with MM were low in viscosity. The GRINDSTED® PS 209/MM sample with powders was higher in viscosity. The results demonstrate that all liquid bread improver samples show reducing viscosity with increasing stress. The samples with MM have the lowest viscosity throughout. The sample of MM and GRINDSTED® PS 209 combined shows similar profiles to that of GRINDSTED® PS 209 alone, albeit at lower viscosity values.

### REFERENCES

Mullin, J. W. (1993) “Crystallisation” 3^{rd} Ed. Butterworth—Heinemann, UK. Pp 292-293.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology or related fields are intended to be within the scope of the following claims.

1. A dispersion comprising
(i) a triglyceride continuous phase;
(ii) a triglyceride dispersed phase; and
(iii) a mono or di ester of glycerol and Moringa oil.

2. A dispersion according to claim 1 wherein the triglyceride continuous phase is a liquid triglyceride.

3. A dispersion according to claim 1 wherein the triglyceride continuous phase is selected from palm oil, rape seed oil, sunflower oil, fish oils, soybean oils, coconut oils, ricebran oils, dag oils, beef tallow, allanblackia oils and shea fat.

4. A dispersion according to claim 2 wherein the triglyceride continuous phase is selected from palm oil, rape seed oil, sunflower oil, fish oils, soybean oils, coconut oils, ricebran oils, dag oils, beef tallow, allanblackia oils and shea fat.

5. A dispersion according to claim 1 wherein the triglyceride dispersed phase is solid triglyceride.

6. A dispersion according to claim 2 wherein the triglyceride dispersed phase is solid triglyceride.

7. A dispersion according to claim 3 wherein the triglyceride dispersed phase is solid triglyceride.

8. A dispersion according to claim 1 wherein the triglyceride dispersed phase is selected from palm oil, rape seed oil, sunflower oil, fish oils, soybean oils, coconut oils, ricebran oils, dag oils, beef tallow, allanblackia oils and shea fat.

9. A dispersion according to claim 2 wherein the triglyceride dispersed phase is selected from palm oil, rape seed oil, sunflower oil, fish oils, soybean oils, coconut oils, ricebran oils, dag oils, beef tallow, allanblackia oils and shea fat.

10. A dispersion according to claim 3 wherein the triglyceride dispersed phase is selected from palm oil, rape seed oil, sunflower oil, fish oils, soybean oils, coconut oils, ricebran oils, dag oils, beef tallow, allanblackia oils and shea fat.

11. A dispersion according to claim 4 wherein the triglyceride dispersed phase is selected from palm oil, rape seed oil, sunflower oil, fish oils, soybean oils, coconut oils, ricebran oils, dag oils, beef tallow, allanblackia oils and shea fat.

12. A dispersion according to claim 5 wherein the triglyceride dispersed phase is selected from palm oil, rape seed oil, sunflower oil, fish oils, soybean oils, coconut oils, ricebran oils, dag oils, beef tallow, allanblackia oils and shea fat.

13. A dispersion according to claim 6 wherein the triglyceride dispersed phase is selected from palm oil, rape seed oil, sunflower oil, fish oils, soybean oils, coconut oils, ricebran oils, dag oils, beef tallow, allanblackia oils and shea fat.

14. A dispersion according to claim 7 wherein the triglyceride dispersed phase is selected from palm oil, rape seed oil, sunflower oil, fish oils, soybean oils, coconut oils, ricebran oils, dag oils, beef tallow, allanblackia oils and shea fat.

15. A dispersion according to claim 1 wherein the dispersion contains water in an amount of less than 1 wt. % based on the total dispersion.

16. A dispersion according to claim 1 wherein the dispersion is a food additive or food ingredient.

17. A dispersion according to claim 2 wherein the dispersion is a food additive or food ingredient.

18. A dispersion according to claim 3 wherein the dispersion is a food additive or food ingredient.

19. A dispersion according to claim 4 wherein the dispersion is a food additive or food ingredient.

20. A dispersion according to claim 5 wherein the dispersion is a food additive or food ingredient.

21. A dispersion according to claim 8 wherein the dispersion is a food additive or food ingredient.

22. A dispersion according to claim 16 wherein the food additive or food ingredient is selected from the group consisting of nut butters, seed butters, shortenings and liquid bread improvers.

23. A dispersion according to claim 16 wherein the food additive or food ingredient is a liquid bread improver.

24. A dispersion according to claim 16 wherein the food additive or food ingredient is selected from group consisting of nut butters and seed butters.

25. A dispersion according to claim 22 wherein the nut butter or seed butter is selected from the group consisting of almond butter, cashew butter, hazelnut butter, macadamia nut butter, peanut butter, pecan butter, pistachio butter, walnut butter, pumpkin seed butter, sesame seed butter (tahini), soybean butter and sunflower seed butter.

26. A dispersion according to claim 24 wherein the nut butter or seed butter is selected from the group consisting of almond butter, cashew butter, hazelnut butter, macadamia nut butter, peanut butter, pecan butter, pistachio butter, walnut butter, pumpkin seed butter, sesame seed butter (tahini), soybean butter and sunflower seed butter.

27. A dispersion according to claim 1 wherein the dispersion is a food suitable for human consumption.

28. A dispersion according to claim 27 wherein the food is selected from candy bars, whipable fillings, protein drinks, beverage whiteners, milk shake concentrates and savoury flavourings.

28. A dispersion according to claim 1 wherein the dispersion is a feed suitable for animal consumption.

29. A dispersion according to claim 28 wherein the feed is selected from poultry feed, aqua culture feed, bovine feed and porcine feed.

30. A process for preparing a dispersion, comprising the steps of
(a) contacting
(i) a first triglyceride; and
(ii) a second triglyceride;
wherein the first triglyceride and second triglyceride are different;
(b) forming a dispersion wherein the first triglyceride provides a continuous phase and wherein the second triglyceride provides a dispersed phase; and
(c) contacting the first triglyceride and the second triglyceride either before step (b) or after step (b) with a mono or di ester of glycerol and Moringa oil.

31. A process for using a mono or di ester of glycerol and Moringa oil to prepare or stabilize a dispersion comprising
(i) a triglyceride continuous phase; and
(ii) a triglyceride dispersed phase
by contacting the mono or di ester of glycerol and Moringa oil to the dispersion.
